(19) United States
(12) Patent Application Publication
(10) Pub. No.: US 2024/0376931 A1
(43) Pub. Date: Nov. 14, 2024

(54) CAGE FOR ROLLING ELEMENTS OF HIGH-SPEED BEARING AND HIGH-SPEED BEARING

(71) Applicant: Aktiebolaget SKF, Göteborg (SE)

(72) Inventors: Hongyuan AN, Shanghai (CN); Chaoxun LU, Shanghai (CN); He ZHU, Shanghai (CN); Hongyan WANG, Shanghai (CN)

(21) Appl. No.: 18/654,139

(22) Filed: May 3, 2024

(30) Foreign Application Priority Data
May 12, 2023 (CN) 202310538459.6

(51) Int. Cl. F16C 33/44

(52) U.S. Cl. CPC F16C 33/44; F16C 2202/06; F16C 2202/08; F16C 2202/64; F16C 2208/60; F16C 2220/04; F16C 2240/48

(57) ABSTRACT

A cage for rolling elements of a high speed bearing. The cage includes a cage body made of a polymer material. The cage body includes a lubrication enhancer and/or an elastic modulus enhancer added to the polymer material during the manufacturing process. The lubrication enhancer makes the cage have a low friction coefficient, low heat generation and good wear resistance, and the cage has better stability when the bearing is under high temperature or high speed. The elastic modulus enhancer makes the cage have an excellent high elastic modulus, and the deformation of the cage is significantly reduced under the condition of high-speed operation of the bearing. These effects can be obtained by adding both the lubrication enhancer and the elastic modulus enhancer at the same time, which makes the cage more suitable for high-speed bearings.

### CROSS-REFERENCE TO RELATED APPLICATION

This application claims priority to Chinese Application No. 202310538459.6, filed May 12, 2023, the entirety of which is hereby incorporated by reference.

### FIELD

The present disclosure relates to a cage for rolling elements of a high-speed bearing and relates to a high-speed bearing.

### BACKGROUND

Bearings are widely used in various aspects of production and life, they usually include rolling elements arranged between an inner ring and an outer ring and a cage for separating and holding the rolling elements.

In some fields, it is necessary to use high-speed bearings, which usually reach thousands of RPM or even tens of thousands of RPM. Some high-speed bearings also use L-shaped cages. In this case, performance of the cage used for bearing rolling elements will affect the operation of the high-speed bearing. Since friction between the cage and the rolling elements will increase under high speed and heat generation will increase, in serious cases, deformation of the cage will enlarge, which may lead to serious problems such as rolling elements falling off and even bearing failure.

Therefore, a new type of cage is needed in the field of high-speed bearing, so that it can ensure a stable operation of the bearing under high speed.

### SUMMARY

In view of the problems and desires mentioned above, the present disclosure provides a new technical solution, which solves the above problems and brings other technical effects by adopting the following technical features.

The present disclosure provides a cage for rolling elements of a high speed bearing comprising: a cage body which is made of a polymer material; wherein, the cage body comprises a lubrication enhancer and/or an elastic modulus enhancer added to the polymer material during the manufacturing process.

The present disclosure also provides a high-speed bearing comprising the cage.

addition of the lubrication enhancer makes the cage have characteristics of low friction coefficient, low heat generation and good wear resistance, and the cage has better stability when the bearing is under high temperature or high speed. Addition of the elastic modulus enhancer makes the cage have an excellent high elastic modulus, and the deformation of the cage is significantly reduced under the condition of high-speed operation of the bearing. The excellent effects of the above two aspects can be obtained by adding both the lubrication enhancer and the elastic modulus enhancer at the same time, which makes the cage of the present disclosure more suitable for high-speed bearings.

### BRIEF DESCRIPTION OF THE DRAWINGS

FIG. 1 is a schematic view of a cage according to some preferable embodiment of the present disclosure, which can be assembled into a bearing;

FIG. 2 is a perspective view of the cage according to some preferable embodiment of the present disclosure.

### DETAILED DESCRIPTION

In order to make the purpose, technical solution and advantages of the technical solution of the present disclosure clearer, the technical solution of the embodiment of the present disclosure will be described clearly and completely in the following with the attached drawings of specific embodiments of the present disclosure. Like reference numerals in the drawings represent like components. It should be noted that a described embodiment is a part of the embodiments of the present disclosure, not the whole embodiments. Based on the described embodiments of the present disclosure, all other embodiments obtained by those skilled in the field without creative labor fall into the scope of protection of the present disclosure.

In comparison with the embodiments shown in the attached drawings, feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by those skilled in the field to which this disclosure belongs. The terms “first”, “second” and similar terms used in the specification and claims of the patent application of this disclosure do not indicate any order, quantity or importance, but are only used to distinguish different components. When the number of components is not specified, the number of components can be one or more. Similarly, terms such as “a/an”, “the” and “said” do not necessarily mean quantity limitation. Similar terms such as “including” or “comprising” mean that the elements or objects appearing before the terms cover the elements or objects listed after the terms and their equivalents, without excluding other elements or objects. Similar terms such as “installation”, “setting”, “connection” or “coupling” are not limited to physical or mechanical installation, setting and connection, but can include electrical installation, setting and connection, whether directly or indirectly. “Up”, “down”, “left” and “right” are only used to indicate the relative orientation relationship when the equipment is used or the orientation relationship shown in the attached drawings. When the absolute position of the described object changes, the relative orientation relationship may also change accordingly.

For the convenience of explanation, the direction of the rotation axis of the bearing to which the cage is applied is called an axial direction, the direction perpendicular to the axial direction is called a radial direction, and the direction along the rotation direction of the bearing is called the circumferential direction. The term “inner/inward” refers to the direction toward the inside of the relevant component, whereas the term “outer/outward” refers to the direction toward the outside of the relevant component.

For the convenience of explanation, the direction of the rotation axis of the bearing is called an axial direction, and the direction perpendicular to the axial direction is called a radial direction. The term “inner/inward” refers to the direction toward the inside of the bearing, whereas the term “outer/outward” refers to the direction toward the outside of the bearing. Moreover, the bearing usually comprises a plurality of rolling elements, and there is a plurality of pockets in the corresponding cage for holding the rolling elements, and thus, for convenience of explanation herein after, a/the rolling element and a/the pocket shall be understood to be “multiple” rather than “single” even though not described with “a plurality of”. In addition, in different embodiments, the same reference numerals are used to refer to components having the same or similar structures and functions.

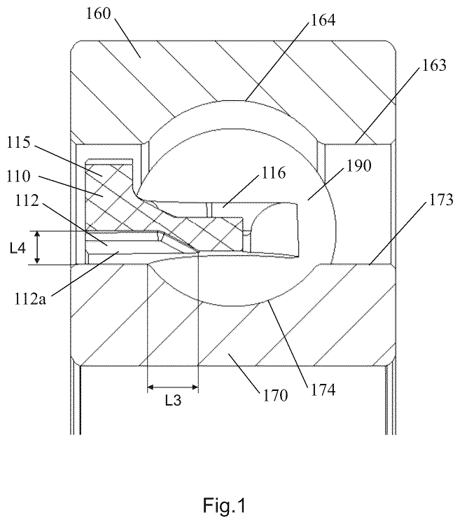

Referring to FIG. 1, a cage according to some preferable embodiment of the present disclosure is shown to be assembled into a high-speed bearing. This kind of high-speed bearing is usually a bearing with ndm (bearing speed factor) above 1,500,000, wherein “ndm” is calculated as rotation speed in RPM of a bearing inner ring multiplied by a pitch circle diameter in mm of bearing rolling element. Specifically, in this field, a pitch circle of bearing rolling element refers to a circle formed by the centers of the rolling elements in an assembled bearing. “n” usually refers to the rotational speed (RPM) of the inner ring relative to the outer ring when the bearing outer ring is stationary, and “dm” is a pitch diameter (mm) of bearing rolling element.

Specifically, the bearing may include an outer ring 160, an inner ring 170, rolling elements 190, and the like. The outer ring 160 also includes an outer ring shoulder 163 and a raceway 164. The inner ring 170 includes an inner ring shoulder 173 and an inner ring raceway 174.

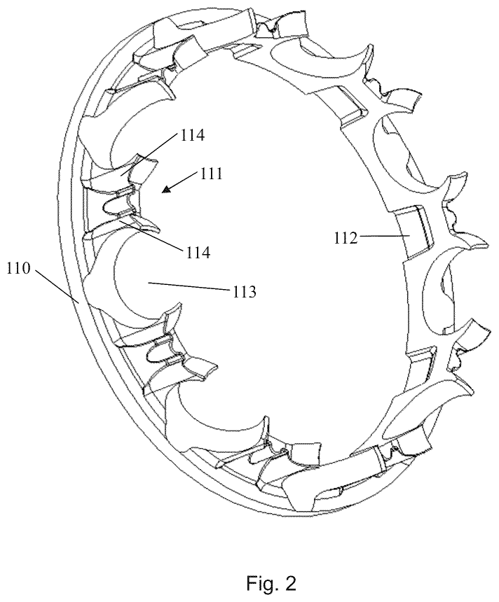

Referring further to FIGS. 1-2, the cage includes a cage body 110. In the preferable embodiment as shown, it is an L-shaped cage with a radial wall 115 and a circumferential wall 116 intersecting with each other. The cage body 110 also includes a cavity 112 on the inner hole of the cage (where 112a is the cavity diameter surface).

Further, L3 is the axial distance from the inner edge of the cavity 112 to the edge of the inner race raceway, and L4 is the radial distance from the cavity 112 to the inner race shoulder 173.

The cage also includes a partition 111 between adjacent pockets 113 and claws 114 on both sides of the partition 111, so that the rolling elements can be held after being pressed into the pockets.

To assembled the bearing, the outer ring and the inner ring are placed horizontally, and the rolling elements are placed in the raceways of the inner and outer rings; then the rolling elements are roughly evenly distributed around the circumferential direction; then, the L-shaped cage is vertically press-fitted into the bearing with the claw-side facing down, so as to keep the rolling elements in the corresponding pockets.

It should be noted that the cage structure shown in FIG. 1 is only used to show some preferable embodiment of the present disclosure, and is not used to limit the specific structure of the cage of the present disclosure. In the embodiment in which the cage of the present disclosure adopts a plug-in cage, the plug-in cage can completely adopt various structures suitable for high-speed environment without being limited to the preferable embodiment shown in FIG. 1. In fact, the cage of the present disclosure can include various types of cages that can be applied to high-speed environments, including but not limited to: various types of fully enclosed cages (such as window-type cages, riveted cages, etc.) and various types of semi-enclosed cages (such as plug-in cages, etc.).

According to the present disclosure, the cage body usually comprises a polymer material. For example, the cage body is formed by injection molding of a polymer material. There may be various choices for the polymer material. Preferably, the polymer material used for forming the cage body may include polyamide resin or polyether ether ketone (PEEK) or polyarylether ketone (PAEK).

The polyamide resin may preferably include, but not limited to, polytetramethylene adipamide (PA46), polypentanediamine adipate (PA56), polyhexamethylene adipamide (PA66), polydecanediamine sebacic anhydride (PA410), polydecanoyl pentanediamine (PA510), poly (p-phenylene terephthaloyl nonyl diamine) (PA9T), or polyphenylenedicarbonyl decanediamine (PA10T).

According to the present disclosure, in the manufacturing process of the cage body, the performance of the cage is optimized by adding the lubrication enhancer and/or the elastic modulus enhancer to the polymer material used for forming the cage body, so that the cage will be particularly suitable for high-speed bearings. Preferably, the cage body is formed by an injection molding process of a polymer material, and a lubrication enhancer and/or an elastic modulus enhancer can be added to the polymer material in the injection molding stage of the injection molding process, for example, powders or particles of the lubrication enhancer and/or the elastic modulus enhancer can be added to the polymer material.

Further preferably, the lubrication enhancer may include perfluoropolyether (PFPE) and/or polytetrafluoroethylene (PTFE), that is, the two lubrication enhancers may be, alone or together, added to the polymer material used for forming the cage body.

By applying lubrication enhancers such as PFPE and PTFE, inner surface of the pocket hole of the cage contacting with the rolling element will have a reduced friction coefficient, thus reducing the friction between the inner surface of the pocket hole and the rolling element will make the cage particularly suitable for high-speed bearings.

In addition, the content of PFPE/PTFE as lubrication enhancer may be 0.5%-15% by weight to achieve an optimal lubrication enhancement effect. Preferably, the content of PFPE/PTFE of the lubrication enhancer maybe 0.5%-10% by weight.

Further preferably, the elastic modulus enhancer may further include carbon fibers and/or glass fibers. By adding carbon fibers and/or glass fibers, the elastic modulus of the cage can be effectively improved, so that possible deformation of the cage can be effectively reduced when the bearing runs under high speed.

Preferably, according to the test method under ISO527, dry state and loading rate of 1 mm/min, the cage has an elastic modulus greater than 15 Gpa, and preferably the cage has an elastic modulus of 15-65 Gpa. In addition, this preferable content of the elastic modulus enhancer (especially by adding carbon fibers and/or glass fibers) also makes the cage have a bending modulus greater than 10 GPa, and preferably, the cage has a bending modulus of 10-45 GPa, according to the test method under ISO178, dry state and loading rate of 1 mm/min. Preferably, according to the test method under ISO179 and dry state, the cage has an impact strength greater than 20 KJ/m2, and preferably, the cage has an impact strength of 20-40 KJ/m2, so that the performance of the cage can be greatly improved. The content of the elastic modulus enhancer is 5%-40% by weight, and more preferably, the content of the elastic modulus enhancer is 12%-38% by weight. In the embodiment where carbon fibers and/or glass fibers are used as the elastic modulus enhancer, the length of the a carbon fiber and/or a glass fiber is 0.1-12 mm, and the diameter of the carbon fiber and/or the glass fiber is 5-20 m. More preferably, the length of the carbon fiber and/or the glass fiber is 0.1-3 mm, and the diameter of the carbon fiber and/or the glass fiber is in a range of 5-15 m, so as to satisfy the performance of the cage and meanwhile avoid long carbon fibers and/or glass fibers interfering the injection molding process.

In addition, the tensile strength of the cage can be greater than 90 MPa by optimizing the materials of the cage. Preferably, PA66, PEEK, PAEK or their combination can be selected as the base material of the cage, and the water absorption rate of the cage can meet the requirement of less than 0.1% through a conditioning process such as water boiling, water absorbing in high temperature and high humidity environment, and this preferable water absorption range greatly reduces the possibility of dimensional change and significant decrease of the elastic modulus of the cage of the present disclosure due to excessive water absorption.

It should be understood that although the present disclosure is described by taking an L-shaped cage as an example in the illustrated preferable embodiment, the principles of the present disclosure can also be applied to cages of other structures and uses.

According to the present disclosure, Addition of the lubrication enhancer makes the cage have characteristics of low friction coefficient, low heat generation and good wear resistance, and the cage has better stability when the bearing is under high temperature or high speed. Addition of elastic modulus enhancer makes the cage have an excellent high elastic modulus, and the deformation of the cage is significantly reduced under the condition of high-speed operation of the bearing. The excellent effects of the above two aspects can be obtained by adding both the lubrication enhancer and the elastic modulus enhancer at the same time, which makes the cage of the present disclosure more suitable for high-speed bearings.

The exemplary implementation of the present disclosure has been described in detail above with reference to the preferable embodiments. However, it can be understood by those skilled in the art that without departing from the concept of the present disclosure, various changes and modifications can be made to the above specific embodiments, and various technical features and structures provided in this disclosure can be combined in various ways without going beyond the protection scope of the present disclosure, which is determined by the appended claims.

What is claimed is:

1. A cage for rolling elements of a bearing with ndm greater than 1,500,000, wherein ndm is calculated as rotational speed in RPM of a bearing inner ring multiplied by pitch diameter in mm of a bearing rolling element, the cage comprising:
a cage body made of a polymer material, the cage body including a lubrication enhancer and/or an elastic modulus enhancer added to the polymer material during the manufacturing process.

2. The cage according to claim 1, wherein the polymer material comprises polyamide resin or PEEK or PAEK.

3. The cage according to claim 1, wherein the lubrication enhancer comprises PFPE and/or PTFE.

4. The cage according to claim 3, wherein the content of the PFPE and/or the PTFE is 0.5%-15% by weight; preferably, the content of the PFPE and/or the PTFE is 0.5%-10% by weight.

5. The cage according to claim 1, wherein the elastic modulus enhancer comprises carbon fibers and/or glass fibers; preferably, the length of a carbon fiber and/or a glass fiber is 0.1-12 mm, and the diameter of the carbon fiber and/or the glass fiber is 5-20 m; more preferably, the length of the carbon fiber and/or glass fiber is 0.1-3 mm, and the diameter of the carbon fiber and/or glass fiber is 5-15 m.

6. The cage according to claim 5, wherein
according to the test method under ISO527, dry state and loading rate of 1 mm/min, the cage has an elastic modulus greater than 15 Gpa, preferably, the cage has an elastic modulus of 15-65 Gpa;
according to the test method under ISO178, dry state and loading rate of 1 mm/min, the cage has a bending modulus greater than 10 GPa, preferably, the cage has a bending modulus of 10-45 GPa; and/or
according to the test method under ISO179 and dry state, the cage has an impact strength greater than 20 KJ/m2, and preferably, the cage has an impact strength greater than 20-40 KJ/m2.

7. The cage according to claim 1, wherein the tensile strength of the cage is greater than 90 MPa.

8. The cage according to claim 1, wherein the water absorption rate of the cage is less than 0.1%.

9. The cage according to claim 1, wherein the cage is an L-shaped cage with a radial wall and a circumferential wall intersecting with each other.

10. The cage according to claim 1, wherein the polymer material comprises a polyamide resin, and the polyamide resin comprises polytetramethylene adipamide, polypentanediamine adipate, polyhexamethylene adipamide, polydecanediamine sebacic anhydride, polydecanoyl pentanediamine, poly (p-phenylene terephthaloyl nonyl diamine), or polyphenylenedicarbonyl decanediamine.

11. The cage according to claim 1, wherein the cage body is formed by an injection molding process of the polymer material, and the lubrication enhancer and/or the elastic modulus enhancer is added to the polymer material in an injection molding stage of the injection molding process.

12. The cage according to claim 4, wherein the elastic modulus enhancer comprises carbon fibers and/or glass fibers; preferably, the length of a carbon fiber and/or a glass fiber is 0.1-12 mm, and the diameter of the carbon fiber and/or the glass fiber is 5-20 m; more preferably, the length of the carbon fiber and/or glass fiber is 0.1-3 mm, and the diameter of the carbon fiber and/or glass fiber is 5-15 m.

13. The cage according to claim 12, wherein
according to the test method under ISO527, dry state and loading rate of 1 mm/min, the cage has an elastic modulus greater than 15 Gpa, preferably, the cage has an elastic modulus of 15-65 Gpa;
according to the test method under ISO178, dry state and loading rate of 1 mm/min, the cage has a bending modulus greater than 10 GPa, preferably, the cage has a bending modulus of 10-45 GPa; and/or
according to the test method under ISO179 and dry state, the cage has an impact strength greater than 20 KJ/m2, and preferably, the cage has an impact strength greater than 20-40 KJ/m2.

14. The cage according to claim 4, wherein the tensile strength of the cage is greater than 90 MPa.

15. The cage according to claim 4, wherein the water absorption rate of the cage is less than 0.1%.

16. A bearing with ndm greater than 1,500,000, comprising the cage according to claim 1.

17. A bearing with ndm greater than 1,500,000, comprising the cage according to claim 13.
